(19) United States
(12) Patent Application Publication
(10) Pub. No.: US 2015/0379804 A1
(43) Pub. Date: Dec. 31, 2015

(54) SLOT GAMES WITH CONNECTED PAYGROUPS ACTING ON SYMBOLS IN A SYMBOL ARRAY

(71) Applicant: Multimedia Games, Inc., Austin, TX (US)

(72) Inventor: Michael Casey, Austin, TX (US)

(21) Appl. No.: 14/315,473

(22) Filed: Jun. 26, 2014

(51) Int. Cl. G07F 17/32; G07F 17/34

(52) U.S. Cl. CPC G07F 17/3213; G07F 17/34

(57) ABSTRACT

A slot machine game includes connected paygroups in a symbol array that causes prizes to be awarded, as an alternative or supplement to traditional paylines. The connected paygroups are defined in a reel spin result by counting symbols of a designated type that are contiguous horizontally or vertically. Preferably the designated type is matching symbols. The connected paygroups may be enhanced by wild symbols increasing their size or linking two or more groups to form a larger single group of contiguous symbols. To receive an award, groups must meet a minimum designated size. Players can wager on different sets of connected paygroup sizes like traditional games allow wagering for numbers of paylines. Bonus rounds are provided with special features that enhance connected paygroup sizes.

### TECHNICAL FIELD OF THE INVENTION

The invention relates to methods for conducting an interactive reel or symbol array type wagering game including variable-sized pay regions defined by the groups symbols within them.

### BACKGROUND OF THE INVENTION

Slot machine games have historically used one or more paylines that pass through the symbols on the game reels in order to define winning patterns and award prizes. Larger arrays of symbols allow for larger numbers of paylines, providing more ways to win and more wagering options for the player. However, complex paylines are sometimes hard to discern for the player, and therefore may lead the player to be less involved in the game. Various slot machine games use features that enhance certain game symbols to improve the game experience for games with reels, simulated reels, or other arrays of gaming symbols. For example, many slot machines have features that turn certain symbols wild in certain situations, or provide various enhancements to the symbols in a spin result that provide for higher prizes when the result is evaluated.

What is needed are more exciting ways to award prizes that can combine with or replace payline award schemes, in order to increase player excitement and enjoyment of slot machine games.

### SUMMARY OF THE INVENTION

The present invention includes a highly entertaining method of conducting a game for one or more players. The entertainment value is achieved by a slot machine game including connected paygroups in a symbol array that causes prizes to be awarded, as an alternative or supplement to traditional paylines. The connected paygroups are defined in a reel spin result by counting symbols of a designated type that are contiguous horizontally or vertically. Preferably the designated type is matching symbols. The connected paygroups may be enhanced by wild symbols increasing their size or linking two or more groups to form a larger single group of contiguous symbols. To receive an award, groups must meet a minimum designated size. Players can wager on different sets of connected paygroup sizes like traditional games allow wagering for numbers of paylines. Bonus rounds are provided with special features that enhance connected paygroup sizes.

Another version of the invention is a computer program stored on a non-transitory readable medium. The software version is, of course, typically designed to be executed by a gaming machine or networked gaming system. The software includes multiple portions of computer executable code referred to as program code. Gaming results are provided in response to a wager and displayed by display program code that generates simulated slot reels each including one or more symbol locations. The program also has game controller program code for determining game play results involving spins or other randomization of an array of symbols, each spin producing a spin result, each spin result having a chance to include one or more of the connected paygroups.

Another version of the invention is a gaming system that includes one or more gaming servers, and a group of electronic gaming machines connected to the servers by a network. The various functionality described herein may be distributed between the electronic gaming machines and the gaming servers in any practically functional way. For example, a Class III architecture may be used in which random number generation and game logic are primarily executed by processors in the electronic gaming machine. Another example architecture is for the servers to determine all aspects of game logic, random number generation, and prize awards. The gaming machines provide functionality of interfacing with the player and animating the game results received from the server in an entertaining manner. However, other embodiments might use a thin client architecture in which the animation is also conducted by the server, and electronic gaming machines serve merely as a terminal to receive button or touch screen input from the player and to display graphics received from the server.

Different features may be included in different versions of the invention. For example, different animation themes may be applied that display the application of the connected paygroups in different ways.

These and other advantages and features of the invention will be apparent from the following description of the preferred embodiments, considered along with the accompanying drawings.

### BRIEF DESCRIPTION OF THE DRAWINGS

FIG. 1A shows an example game screen diagram showing a connected paygroups feature according to one embodiment.

FIG. 1B shows another example game screen diagram with a different connected paygroups feature according to another embodiment.

FIG. 2A is a flow chart showing the general method of play for an example embodiment including connected paygroups according to one embodiment the invention.

FIG. 2B is a flow chart showing a game method using a connected paygroups feature according to another embodiment.

FIG. 2C is a flow chart of an embodiment in which connected paygroups are used in a free-spin bonus round.

FIG. 2D shows a block diagram of a number of options that may be used in various embodiments to allow the player to adjust their wager.

FIG. 3A is a front perspective view of a gaming machine which may be used in a gaming system embodying the principles of the present invention.

FIG. 3B is a block diagram showing various electronic components of the gaming machine shown in FIG. 3A together with additional gaming system components.

FIG. 4A is a system block diagram of a gaming system according to one embodiment of the present invention.

FIG. 4B is a system block diagram of a gaming system according to another embodiment.

### DETAILED DESCRIPTION OF PREFERRED EMBODIMENTS

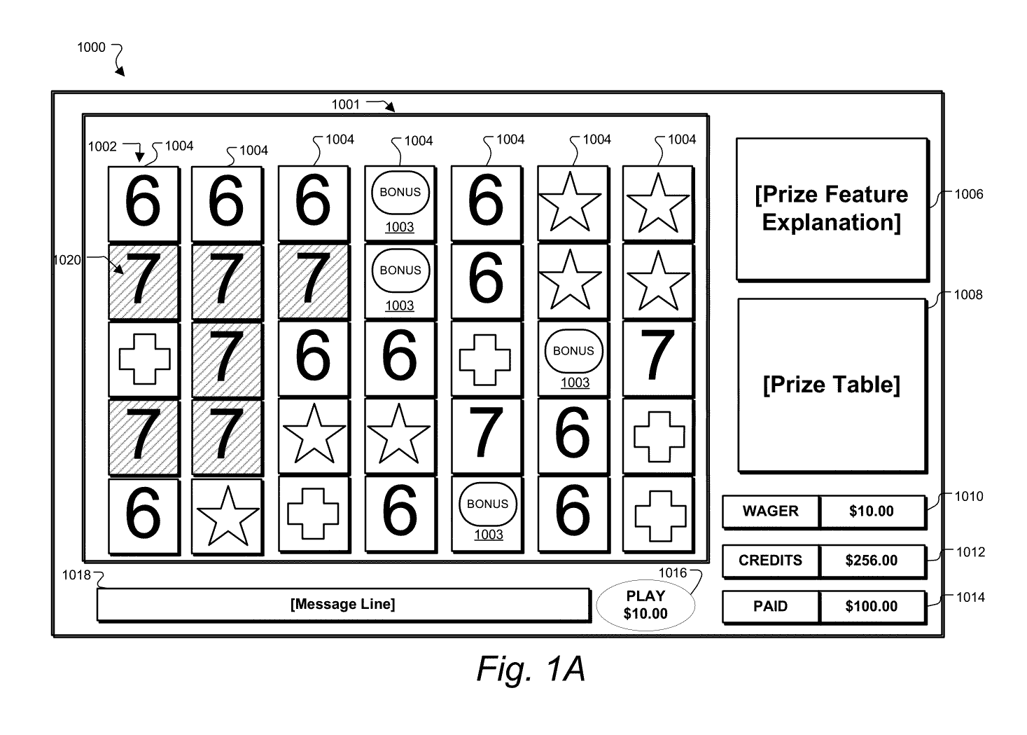

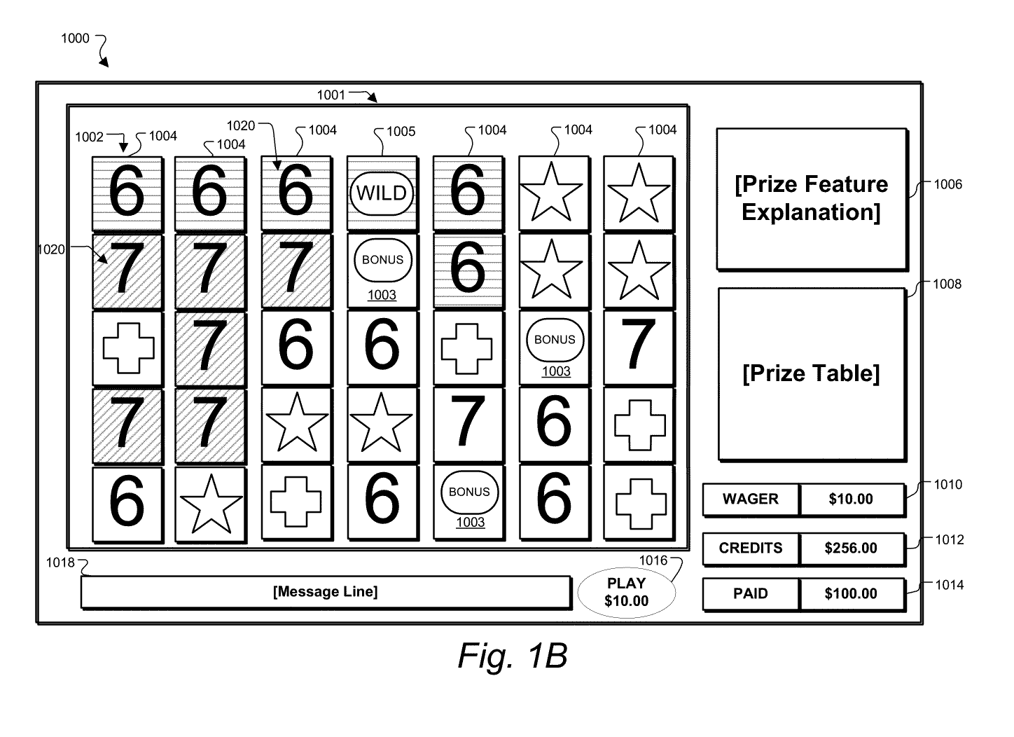

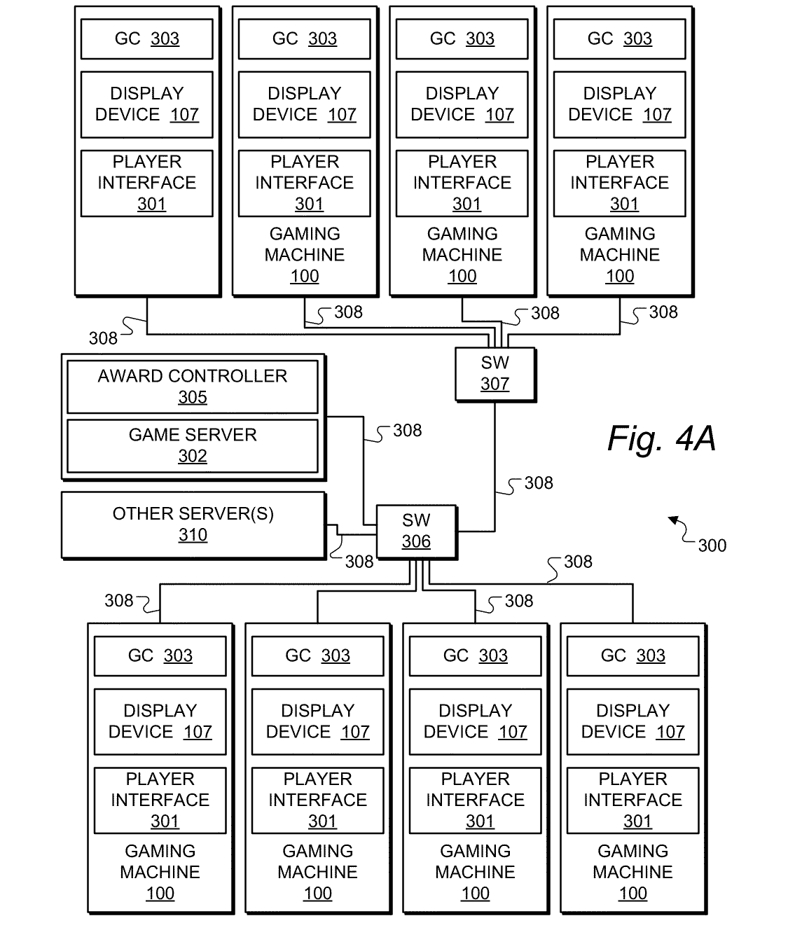

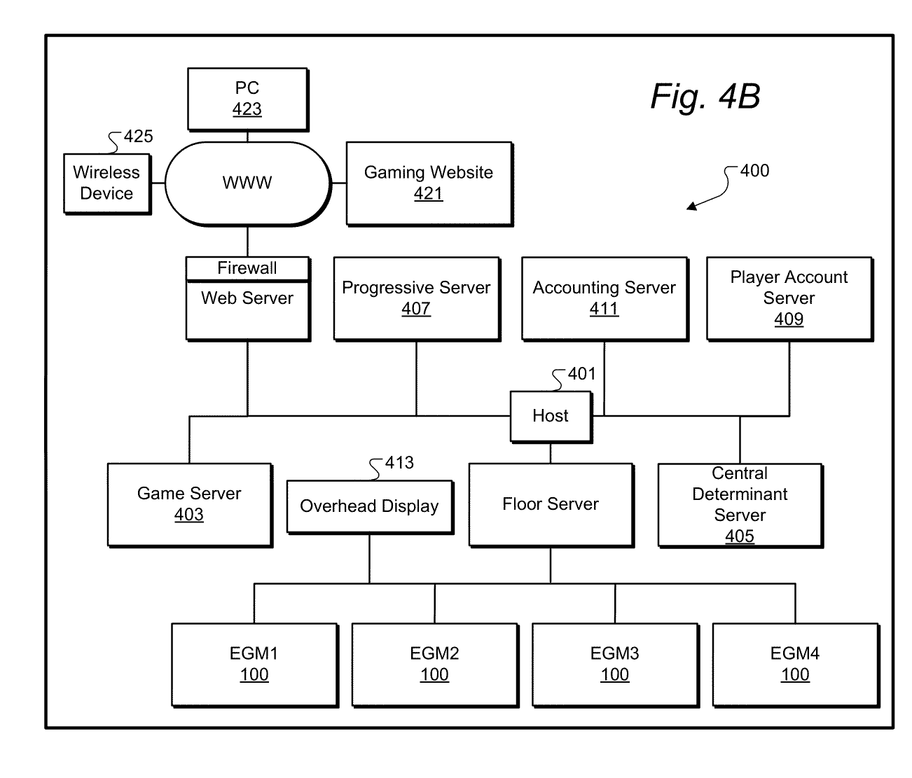

FIG. 1A shows an example game screen diagram 1000, which would be displayed at various gaming machines 100 shown in FIG. 4A to implement the connected paygroups feature of the invention. In this embodiment, the graphic display includes a matrix of symbol locations 1001 (“matrix”, “array”) that displays symbols in five symbol locations 1004 on each of seven separate columns 1002. All the symbols in the group are updated in response to player wager and game activation input to display a new set of symbols in the array. The array may function as a number of simulated unisymbol reels, simulated multisymbol reels, or individual randomized locations that are updated according to a suitable randomized scheme to achieve the desired variability. Rather than defining specific arbitrary subsets of the spin result as paylines, where winning combinations must occur within those subsets and typically in a specific order, a connected paygroup is defined according to the number of connected, contiguous symbols of the same type, which can appear anywhere on the screen, and the pay is determined by the number of symbols of that type in the paygroup. It is noted that to achieve the desired game math, a game according to the invention preferably has fewer unique symbols in the symbol set than traditional payline games to enable larger groups of matching symbols to form more often than would occur with large symbol sets.

In this embodiment of the invention, a slot machine matrix game employs the connected paygroups 1020, which are groups of designated symbols that meet a defined minimum size, in this case identical symbols in groups of five or more horizontally or vertically contiguous symbols. Preferably the connected paygroups are employed instead of traditional paylines in base game play and any bonus rounds, but this is not limiting and the feature may be used in any suitable game. The feature may be used in combination with any traditional paylines scheme, with suitable adjustments to the payline paytable to achieve a desired payout. The award for a connected paygroup preferably depends directly upon the size of the group, with the prize table including larger awards for larger groups, as further described below. In some versions, the award also depends directly on the type of symbol in the group, with multiple symbol types being defined within the set of symbols used in the array. For example, if a card game theme is used, number cards might have a table with lower prizes for ever size group, facecards might have a table with medium sized prizes for each sized group, and the joker and bonus symbols might have a table with large sized prizes for each sized group. Depicted in the base game result shown in matrix 1001 is an example connected paygroup 1020, consisting of six “7” symbols which have been highlighted or emphasized visually to show the connected playgroup to the player. Further, the step of highlighting or otherwise visually emphasizing the group may also include displaying a number visually associated or superimposed with the group on the display, the number being the size of the group. The six symbols are included qualify as a connected paygroup, in this version, because they are matching symbols horizontally or vertically contiguous with each other in a group of five or more. In this version, the designated types of symbols used to define groups are matching symbols only, however in other versions symbols may be designated to form groups in any other suitable manner. It is noted that a typical game design employing connected paygroups according to the invention will use a smaller symbol set than the common payline schemes employed in slot machines, although this is not limiting and some versions of the invention may use large symbol sets. Also depicted are bonus symbols 1003, which can trigger a free bonus round if they appear in a designated trigger pattern such as a scatter or connected group of a defined size.

The graphic display 1000 also includes a box 1006 for displaying texts regarding prize features. There may also be displayed a prize table 1008. A group of accounting indicators at the lower right displays various pieces of data such as the current wager box 1010, available credits 1012, and/or payouts 1014. The touch screen play button 1016 also displays the wager for each game. A message line 1018 displays messages concerning game progress, results, and related information.

FIG. 1B is a game screen diagram showing a different game outcome, in this version using a wild symbol to enhance the possibility of connected paygroups being formed and increase the size of connected paygroups. Depicted on the array 1001 are two connected paygroups 1020, a group of “7” symbols similar to that in FIG. 1A, and a group 1020 of “6” symbols, formed with the use of a wild symbol 1005 evaluated as a “6” symbol. In this embodiment, the set of symbols includes a wild symbol which may appear zero or more times each time the matrix is updated to show a new set of symbols. The step of defining zero or more groups for each outcome therefore includes counting the wild symbol as part of every group to which it is horizontally or vertically contiguous. Further, if two groups of similar symbols are separated by a wild symbol location, such as the two groups of “6” symbols separated by wild symbol 1005, the wild symbol connects the two groups larger group including the two groups and the wild symbol location. In this example, neither group alone would have met the minimum size requirement of five symbols to receive an award, and so the wild symbol created an award where there was not one without it. In other situations, the wild symbol may join two prize-qualifying groups to create a larger group, or join a qualifying group to a non-qualifying group to increase the size of the qualifying group. Any subset of these wild symbol capabilities may be employed in various embodiments. In some versions, a wild may also substitute for only a specific subgroup of symbols, such as picture card symbols in a card game theme, for example.

While two variations of symbol array type games are shown, the techniques herein may be employed with any suitable slot machine games that use randomized groups of symbols as the basis of the games. In one alternative version, for example, the matrix of symbol locations includes X (horizontal), Y (vertical), and Z (depth) dimensions with at least two symbol locations deep in the Z dimension. 3D graphics are employed to display the depth of the matrix. This version allows wherein the groups may be formed additionally by being adjacent in the Z dimension.

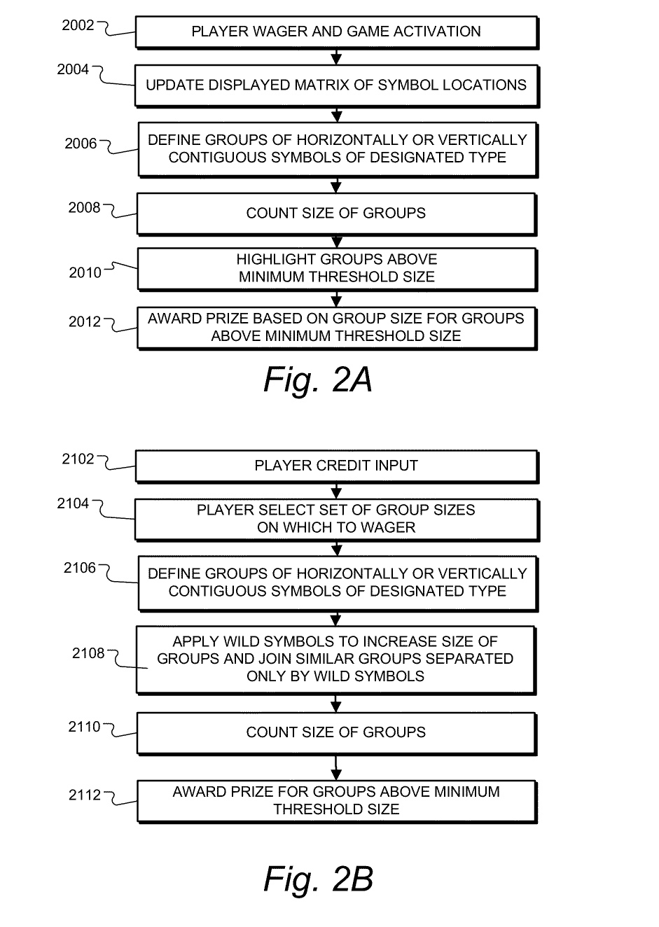

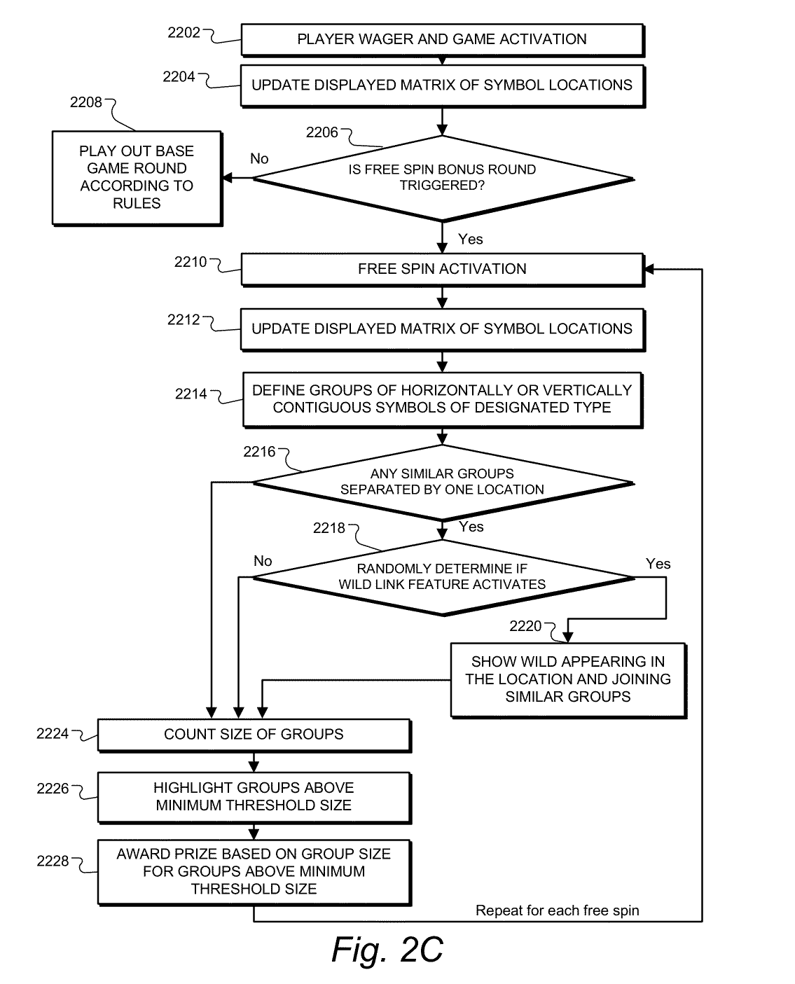

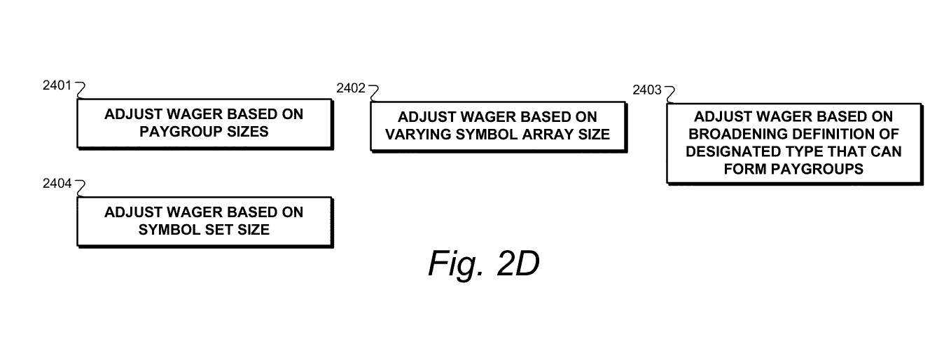

FIG. 2A is a flow chart showing the general method of play for an example embodiment including connected paygroups according to one embodiment of the invention. The depicted method preferably takes place in the context of the base game, but may also be employed in the context of a bonus game round. In such a case, the wager portion of step 2002 is obviously skipped for the free spins, and a base game round with a free spin award must precede the bonus round.

Process in FIG. 2A begins with displaying an initial state of the array which typically includes some arrangement of symbols in the symbol locations of the array. To begin a game play, the process receives a wager from the game player at step 2002, which includes some input from the player to set the amount to be wagered from their credit amount on the machine. This step may also be carried over from previous game rounds by simply starting the game with the previous wager amount set. Then, the process receives a play input from the player, such as through a ‘Play’ button on the game cabinet or touchscreen display, initiates the wager and starts a single round of game play in the base game. Next at step 2004, the process begins conducting the activated game by showing the matrix of symbols being updated with new symbols by some randomizing technique. In embodiments having reels, reels displays, or simulated reels, this is conducted by spinning the reels. Other embodiments may otherwise rearrange or randomize the symbols on the matrix in any suitable manner After the randomization stops, at step 2006, the process next finds groups of contiguous symbols of a designated type (matching symbols in the preferred embodiment), and counts the size of the groups at step 2008. Then at step 2010, the process highlights groups above a defined minimum threshold such as five symbols, and awards prizes for groups above the threshold at step 2012. The highlighting may also announce the size of the group by showing the size as a number superimposed on the group or visually connected to the group.

FIG. 2B is a flow chart showing an alternative game process using a connected paygroups feature according to another embodiment. This game process proceeds similarly to the process of FIG. 2A at steps 2102-2106, but it has an additional step 2108 which employs wild symbols which may be “spun up” or appear in the reels or symbol set used to populate the matrix of symbol locations 1001, such as the wild symbol 1005 in FIG. 1B. The process of FIG. 2B defines groups (step 2106) by finding horizontally or vertically contiguous symbols of a designated type, and then applies any wild symbols (step 2108) on the array to increase the size of groups if the wild symbol(s) is contiguous to the group, or join to groups to form a much larger group if one or more wild symbols join two groups. It is noted that groups too small to qualify for a prize by themselves can be joined to a larger qualifying group, or two or more groups all too small to qualify might be joined by wilds to form a larger qualifying group. Preferably, wilds count as part of any group they touch, which means they can be applied as different types of symbols to enhance multiple groups to which they are contiguous. After the wild symbols are applied in the process, it goes to step 2110 where it considers the size of the groups and at step 2112 awards a prize for groups over a designated threshold size.

FIG. 2C is a flowchart for a free spin bonus round process that employs connected paygroups according to one embodiment. The process begins with step 2202 with the player wager and base game activation, which results in the updated matrix (step 2204) of symbol locations as described above. Next at step 2206, the process determines if a free spin bonus round is triggered in the matrix, such as by a suitable scatter pattern, bonus symbol, or bonus pattern. The trigger may be also a mystery trigger. If no free spin bonus is triggered, the base game round is played out normally at step 2208. If a free spin bonus is triggered, the process goes to step 2210, where it awards the base prize and then shows the transition to the free spin round and begins the round with a free spin activation. Each free spin updates the matrix of locations at step 2212, and the paygroup process occurs to search for and define groups of contiguous symbols of designated types (step 2214). This bonus has a special feature that may join two groups by adding a wild symbol to award a higher bonus prize, if the groups are separated by a single space. The process works by checking if there are similar groups separated by one location at step 2216. If there are, the free spin outcome is eligible for the paygroup bonus enhancement, and the process goes to step 2218 where it randomly determines if the enhancement will activate. If the determination is yes, the process goes to step 2220, where it shows a wild symbol appearing on the matrix to replace the previous symbol at the one location identified in step 2216. This wild symbol joins the two groups, and adds one more to the count of the group size (from the added wild symbol), such that when the group size is determined at step 2224, a much larger size is achieved than before the enhancement. The process then awards prizes for paygroups similarly to the base game process by highlighting groups above a minimum threshold size at step 2226, and awarding a prize based on the size of the groups at step 2228. The process goes back to step 2210 to repeat the free spin activation until all free spins in the round are exhausted, or a trigger condition ends the free spin round.

It is noted that while a wild symbol paygroup enhancement is described here as an example bonus enhancement, many other suitable bonus enhancements are possible with the paygroup scheme described herein. For example, an enhancement triggering symbol may cause the threshold for paygroup payouts to lower and thereby achieve more payouts. This effect might last for one spin in the base or bonus round, or might last for several or all remaining spins in a free spin bonus round. As another example, the free spin bonus round may automatically lower the threshold for paygroup size to pay out (a smaller prize would be provided for the new smaller group size), thereby providing more frequent payouts in the free spin bonus round.

FIG. 2D shows a block diagram of a number of options that may be used in various embodiments to allow the player to adjust their wager. Wager adjustments in a traditional payline game are limited—typically by proving the player the ability to wager on more paylines at a time, with the higher wagers on more paylines enabling bonus features such as bonus symbols, progressives, and higher paytables. The techniques of the present invention allow different ways to allow players to vary their wager to change the characteristics of the game in the context of using paygroups instead of or in addition to, paylines. The options shown will not necessarily all be present in any one version of the invention. As shown at block 2401, the player may vary their wager by betting on more paygroup sizes. This may be done by allowing them to reduce the paygroup payout threshold from five to four, for an additional wager. Or, it may enable larger paygroups, with larger resulting prizes, to be formed in any particular spin. Variability with the payouts may be further controlled by not only basing the prize for a paygroup directly upon the size of the paygroup, but also directly upon the type of symbol used to form the paygroup. For example, a matching set of five “7” symbols would achieve a higher prize than a matching set of five “6” symbols. The prize may also be based directly on the type of symbol in the group as described above. These paytables can be varied to achieve the desired game math when the player varies their wager according to the options herein. At block 2402, the player has the option to wager more to use a larger sized symbol array, which of course gives more chances for forming paygroups. At block 2403, the player has the option adjust their wager by wagering on a broader definition of the designated type of symbol that may form a paygroup. This means, that unlike the examples herein where paygroups are formed by matching symbols of the same type, the player may increase their wager and allow paygroups to form from different but related or closely related symbols such as, for example, numbered symbols that are one number apart, different symbols of the same color, or other suitable choices of different symbols that grouped into a designated type for forming paygroups. Preferably, the designated types that can form paygroups are visually similar such that the player can quickly recognize a group on the screen, which increases player involvement in the game. Another wagering option that may be used is shown in block 2404, which provides the ability by different wagers to use different symbol set sizes (or frequencies of symbol appearance in the set). This can achieve more frequent prizes because a smaller symbol set will result in matching symbols more often being contiguous or adjacent and thereby forming more and larger groups. Preferably this option involves wagering more credits for a smaller symbol set.

In the preferred version, the above described game is provided on a gaming network such as that of FIG. 4B. Preferably a Class III architecture is employed with random number generation and game functionality implemented on the EGM. It should be understood that this is only one example embodiment, and other versions may divide the processing tasks of the game process in a different manner. For example, some systems may employ a thin client architecture in which practically all of the processing tasks are performed at the game server, and only display information for the player interface transmitted to the electronic gaming machine. In such an embodiment, only the steps involving player input or display are performed by the electronic gaming machine, with the remaining steps performed by one of the game servers in the system. In such a case, though, the software architecture is preferably designed as a thin client in which a dedicated virtual machine running on the game server (or a virtual machine server connected in the gaming network) performs the tasks designated in the present drawing as occurring “at the gaming machine.” In the depicted process, the process is performed by the respective computer hardware operating under control of computer program code. While central processor arrangements may vary (for example award controllers may be integrated on the same machine with a gaming server, or may be a separate server connected on a secure network), the particular central determinant architecture is not limiting and will be referred to generally in this drawing as the game server (i.e. 302, 403). As shown at step 2002 in FIG. 2A, the process performed at the game server further includes receiving game play requests originating from electronic gaming machine 100, and sending commands to the gaming machine to show reels spinning, connected paygroups appearing, and results being displayed. The division of game logic steps between gaming machines and servers is known in the art and may be accomplished according to suitable process allowed for the relevant gaming jurisdictions.

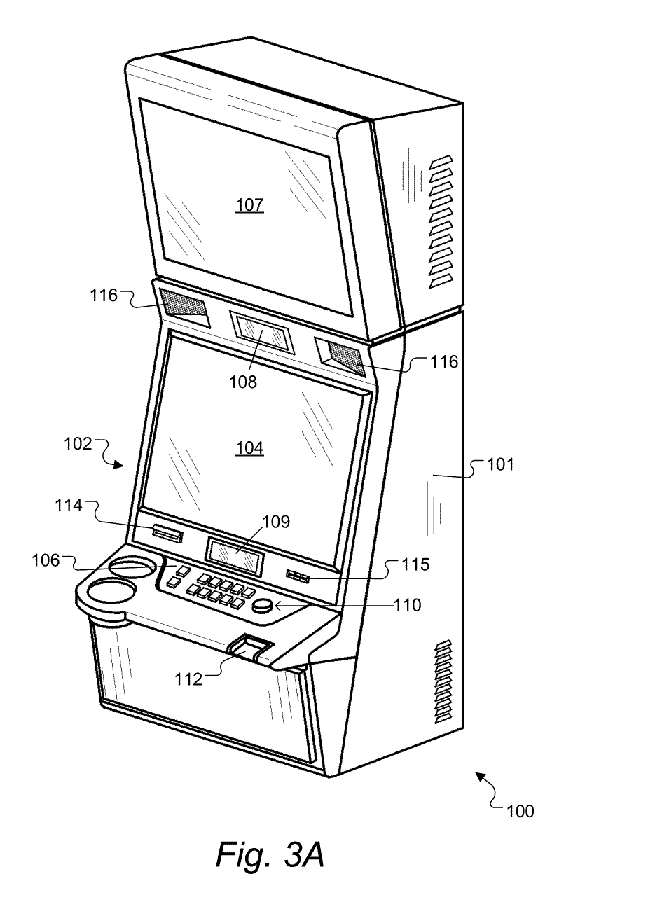

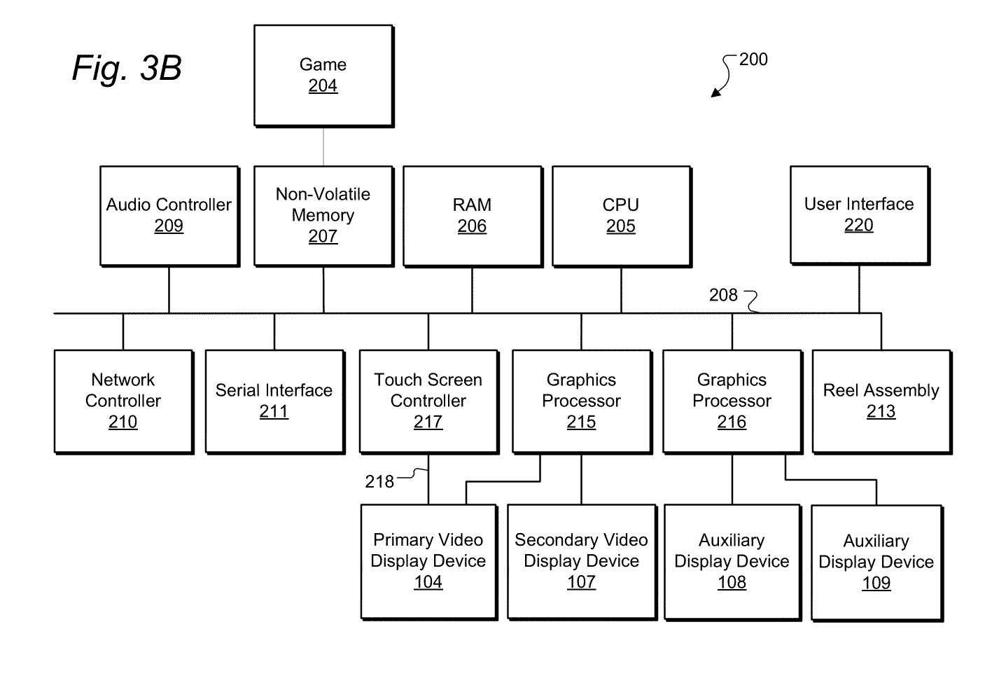

FIG. 3A shows a gaming machine 100 that may be used to implement a connected paygroups game according to the present invention. The block diagram of FIG. 3B shows further details of gaming machine 100. Referring to FIG. 3A, gaming machine 100 includes a cabinet 101 having a front side generally shown at reference numeral 102. A primary video display device 104 is mounted in a central portion of the front surface 102, with a ledge 106 positioned below the primary video display device and projecting forwardly from the plane of the primary video display device. In addition to primary video display device 104, the illustrated gaming machine 100 includes a secondary video display device 107 positioned above the primary video display device. Gaming machine 100 also includes two additional smaller auxiliary display devices, an upper auxiliary display device 108 and a lower auxiliary display device 109. It should also be noted that each display device referenced herein may include any suitable display device including a cathode ray tube, liquid crystal display, plasma display, LED display, or any other type of display device currently known or that may be developed in the future.

In preferred versions, the gaming machine 100 illustrated in FIG. 3A also includes a number of mechanical control buttons 110 mounted on ledge 106. These control buttons 110 may allow a player to select a bet level, select pay lines, select a type of game or game feature, and actually start a play in a primary game. Other forms of gaming machines according to the invention may include switches, joysticks, or other mechanical input devices, and/or virtual buttons and other controls implemented on a suitable touch screen video display. For example, primary video display device 104 in gaming machine 100 provides a convenient display device for implementing touch screen controls.

It will be appreciated that gaming machines may also include a number of other player interface devices in addition to devices that are considered player controls for use in playing a particular game. Gaming machine 100 also includes a currency/voucher acceptor having an input ramp 112, a player card reader having a player card input 114, and a voucher/receipt printer having a voucher/receipt output 115. Audio speakers 116 generate an audio output to enhance the user's playing experience. Numerous other types of devices may be included in gaming machines that may be used according to the present invention.

FIG. 3B shows a logical and hardware block diagram 200 of gaming machine 100 which includes a central processing unit (CPU) 205 along with random access memory 206 and nonvolatile memory or storage device 207. All of these devices are connected on a system bus 208 with an audio controller 209, a network controller 210, and a serial interface 211. A graphics processor 215 is also connected on bus 208 and is connected to drive primary video display device 104 and secondary video display device 107 (both mounted on cabinet 101 as shown in FIG. 3A). A second graphics processor 216 is also connected on bus 208 in this example to drive the auxiliary display devices 108 and 109 also shown in FIG. 3A. As shown in FIG. 3B, gaming machine 100 also includes a touch screen controller 217 connected to system bus 208. Touch screen controller 217 is also connected via signal path 218 to receive signals from a touch screen element associated with primary video display device 104. It will be appreciated that the touch screen element itself typically comprises a thin film that is secured over the display surface of primary video display device 104. The touch screen element itself is not illustrated or referenced separately in the figures.

Those familiar with data processing devices and systems will appreciate that other basic electronic components will be included in gaming machine 100 such as a power supply, cooling systems for the various system components, audio amplifiers, and other devices that are common in gaming machines. These additional devices are omitted from the drawings so as not to obscure the present invention in unnecessary detail.

All of the elements 205, 206, 207, 208, 209, 210, and 211 shown in FIG. 3B are elements commonly associated with a personal computer. These elements are preferably mounted on a standard personal computer chassis and housed in a standard personal computer housing which is itself mounted in cabinet 101 shown in FIG. 3A. Alternatively, the various electronic components may be mounted on one or more circuit boards housed within cabinet 101 without a separate enclosure such as those found in personal computers. Those familiar with data processing systems and the various data processing elements shown in FIG. 3B will appreciate that many variations on this illustrated structure may be used within the scope of the present invention. For example, since serial communications are commonly employed to communicate with a touch screen controller such as touch screen controller 217, the touch screen controller may not be connected on system bus 208, but instead include a serial communications line to serial interface 211, which may be a USB controller or a IEEE 1394 controller for example. It will also be appreciated that some of the devices shown in FIG. 3B as being connected directly on system bus 208 may in fact communicate with the other system components through a suitable expansion bus. Audio controller 209, for example, may be connected to the system via a PCI bus. System bus 208 is shown in FIG. 3B merely to indicate that the various components are connected in some fashion for communication with CPU 205 and is not intended to limit the invention to any particular bus architecture. Numerous other variations in the gaming machine internal structure and system may be used without departing from the principles of the present invention.

It will also be appreciated that graphics processors are also commonly a part of modern computer systems. Although separate graphics processor 215 is shown for controlling primary video display device 104, secondary video display device 107, and graphics processor 216 is shown for controlling both auxiliary display devices 108 and 109, it will be appreciated that CPU 205 may control all of the display devices directly without any intermediate graphics processor. The invention is not limited to any particular arrangement of processing devices for controlling the video display devices included with gaming machine 100. Also, a gaming machine implementing the present invention is not limited to any particular number of video display device or other types of display devices.

In the illustrated gaming machine 100, CPU 205 executes software which ultimately controls the entire gaming machine including the receipt of player inputs and the presentation of the graphic symbols displayed according to the invention through the display devices 104, 107, 108, and 109 associated with the gaming machine. As will be discussed further below, CPU 205 either alone or in combination with graphics processor 215 may implement a presentation controller for performing functions associated with a primary game that may be available through the gaming machine and may also implement a game client for directing one or more display devices at the gaming machine to display portions of a connected paygroup game according to the present invention. CPU 205 also executes software related to communications handled through network controller 210, and software related to various peripheral devices such as those connected to the system through audio controller 209, serial interface 211, and touch screen controller 217. CPU 205 may also execute software to perform accounting functions associated with game play. Random access memory 206 provides memory for use by CPU 205 in executing its various software programs while the nonvolatile memory or storage device 207 may comprise a hard drive or other mass storage device providing storage for programs not in use or for other data generated or used in the course of gaming machine operation. Network controller 210 provides an interface to other components of a gaming system in which gaming machine 100 is included. In particular, network controller 210 provides an interface to a game controller which controls certain aspects of the connected paygroup game as will be discussed below in connection with FIGS. 3A-B.

It should be noted that the invention is not limited to gaming machines employing the personal computer-type arrangement of processing devices and interfaces shown in example gaming machine 100. Other gaming machines through which a connected paygroup game is implemented may include one or more special purpose processing devices to perform the various processing steps for implementing the present invention. Unlike general purpose processing devices such as CPU 205, these special purpose processing devices may not employ operational program code to direct the various processing steps.

It should also be noted that the invention is not limited to gaming machines including only video display devices for conveying results. It is possible to implement a connected paygroup game within the scope of the present invention using an electro mechanical arrangement or even a purely mechanical arrangement for displaying the symbols needed to complete the connected paygroup game as described herein. However, the most preferred forms of the invention utilize one or more video display devices for displaying the spinning reels, the accumulated symbols, and the connected paygroup feature. For example, a gaming machine suitable for providing a connected paygroup game may include a mechanical reel-type display rather than a video-type display device for displaying results in a primary game, and include a video display device for presenting the connected paygroup feature in a bonus game.

Still referring to the hardware and logical block diagram 200 showing an example design for a gaming machine 100, the depicted machine in operation is controlled generally by CPU 205 which stores operating programs and data in memory 207 with wagering game 204, user interface 220, network controller 210, audio/visual controllers, and reel assembly 213 (if mechanical reel configuration). CPU or game processor 205 may comprise a conventional microprocessor, such as an Intel® Pentium® microprocessor, mounted on a printed circuit board with supporting ports, drivers, memory, software, and firmware to communicate with and control gaming machine operations, such as through the execution of coding stored in memory 207 including one or more wagering games 204. Game processor 205 connects to user interface 220 such that a player may enter input information and game processor 205 may respond according to its programming, such as to apply a wager and initiate execution of a game.

Game processor 205 also may connect through network controller 210 to a gaming network, such as example casino server network 400 shown in FIG. 4B. Referring now to FIG. 4B, the casino server network 400 may be implemented over one or more site locations and include host server 401, remote game play server 403 (which may be configured to provide game processor functionality including determining game outcomes and providing audio/visual instructions to a remote gaming device), central determinant server 405 (which may be configured to determine lottery, bingo, or other centrally determined game outcomes and provide the information to networked gaming machines 100 providing lottery and bingo-based wagering games to patrons), progressive server 407 (which may be configured to accumulate a progressive pool from a portion of wagering proceeds or operator marketing funds and to award progressive awards upon the occurrence of a progressive award winning event to one or more networked gaming machines 100), player account server 409 (which may be configured to collect and store player information and/or awards and to provide player information to gaming machines 100 after receiving player identification information such as from a player card), and accounting server 411 (which may be configured to receive and store data from networked gaming machines 100 and to use the data to provide reports and analyses to an operator). Through its network connection, gaming machine 100 may be monitored by an operator through one or more servers such as to assure proper operation, and, data and information may be shared between gaming machine 100 and respective of the servers in the network such as to accumulate or provide player promotional value, to provide server-based games, or to pay server-based awards.

Referring now to FIG. 4A, a gaming system 300 according to another embodiment of the present invention is shown again in a network and system diagram format. System 300 includes a number of gaming machines, each comprising a gaming machine 100 in this example implementation. For purposes of describing system 300, each gaming machine 100 in FIG. 4A is shown as including a video display device 107 and a player interface that may include buttons, switches, or other physical controls and/or touch screen controls as discussed above in connection with FIG. 4A. This player interface is labeled 301 in FIG. 4A. System 300 further includes a game server 302 and a respective game client 303 (abbreviated “GC” in FIG. 4A) included with each respective gaming machine 100. In the form of the invention shown in FIG. 4A these two components, game server 302 and the game client components 303 combine to implement a game control arrangement which will be described in detail below. System 300 also includes an award controller 305, which is shown in FIG. 4A as being associated with game server 302 to indicate that the two components may be implemented through a common data processing device/computer system. Gaming machines 100, game server 302, and award controller 305 are connected in a network communication arrangement including first and second network switches 306 and 307, connected together through various wired or wireless signal paths, all shown as communications links 308 in FIG. 4A.

Each gaming machine 100, and particularly player interface 301 associated with each gaming machine, allows a player to make any inputs that may be required to make the respective gaming machine eligible for a connected paygroup game, and make selections of any selectable objects displayed at the respective gaming machine in the course of the connected paygroup game. Player interface 301 also allows a player at the gaming machine to initiate plays in a primary game available through the gaming machine in some implementations. The respective video display device 107 associated with each respective gaming machine 100 is used according to the invention to generate the graphic displays to show the various elements of a connected paygroup game at the respective gaming machine.

The game control arrangement made up of game server 302 and the respective game client 303 at a given gaming machine functions to control the respective video display device 107 for that gaming machine to display a connected paygroup game graphics. Award controller 305 is responsible for awarding prizes for a player's participation in a connected paygroup game, and maintaining progressive prize information where the connected paygroup game offers one or more progressive prizes. The network arrangement made up of network switches 306 and 307, and the various communication links 308 shown in FIG. 4A is illustrated merely as an example of a suitable communications arrangement. It should be noted that the game control arrangement, or as it is referred to generally the “game controller,” may be implemented in some embodiments entirely on the gaming machine. This is especially true in jurisdictions that allow Class III gaming conducted with random number generators at each gaming machine. The present invention is not limited to any particular communications arrangement for facilitating communications between game server 302 and various gaming machines 100. Any wired or wireless communication arrangement employing any suitable communications protocols (such as TCP/IP for example) may be used in an apparatus according to the invention.

FIG. 4A shows other server(s) 310 included in the network. This illustrated “other server(s)” element 310 may include one or more data processing devices for performing various functions related to games conducted through system 300 and any other games that may be available to players through gaming machines 100. For example, apparatus 300 may be accounting servers providing support for cashless gaming or various forms of mixed cash/cashless gaming through the various gaming machines 100. In this example, an additional one of the other servers 310 will be included in apparatus 300 for supporting these types of wagering and payout systems. As another example, the various gaming machines 100 included in system 300 may allow players to participate in a game (primary game) other than the connected paygroup game described herein, and this other game may rely on a result identified at or in cooperation with a device that is remote from the gaming machines. In this example, another server 310 may be included in the system for identifying results for the primary game and communicating those results to the various gaming machines 100 as necessary. Generally, the other server(s) 310 shown in FIG. 4A are shown only to indicate that numerous other components may be included along with the elements that participate in providing connected paygroup games according to the present invention. Other server(s) 310 may provide record keeping, player tracking, accounting, result identifying services, or any other services that may be useful or necessary in a gaming system.

Referring to FIG. 4B, a block diagram of another example networked gaming system 400 associated with one or more gaming facilities is shown, including one or more networked gaming machines 100 in accordance with one or more embodiments. With reference to FIG. 4B, while a few servers have been shown separately, they may be combined or split into additional servers having additional capabilities.

As shown, networked gaming machines 100 (EGM1-EGM4) and one or more overhead displays 413 may be network connected and enable the content of one or more displays of gaming machines 100 to be mirrored or replayed on an overhead display. For example, the primary display content may be stored by the display controller or game processor 205 and transmitted through network controller 210 to the overhead display controller either substantially simultaneously or at a subsequent time according to either periodic programming executed by game processor 205 or a triggering event, such as a jackpot or large win, at a respective gaming machine 100. In the event that gaming machines 100 have cameras installed, the respective players' video images may be displayed on overhead display 413 along with the content of the player's display 100 and any associated audio feed.

In one or more embodiments, game server 403 may provide server-based games and/or game services to network connected gaming devices, such as gaming machines 100 (which may be connected by network cable or wirelessly). Progressive server 407 may accumulate progressive awards by receiving defined amounts (such as a percentage of the wagers from eligible gaming devices or by receiving funding from marketing or casino funds) and provide progressive awards to winning gaming devices upon a progressive event, such as a progressive jackpot game outcome or other triggering event such as a random or pseudo-random win determination at a networked gaming device or server (such as to provide a large potential award to players playing the community feature game). Accounting server 411 may receive gaming data from each of the networked gaming devices, perform audit functions, and provide data for analysis programs, such as the IGT Mariposa program bundle.

Player account server 409 may maintain player account records, and store persistent player data such as accumulated player points and/or player preferences (e.g. game personalizing selections or options). For example, the player tracking display may be programmed to display a player menu that may include a choice of personalized gaming selections that may be applied to a gaming machine 100 being played by the player.

In one or more embodiments, the player menu may be programmed to display after a player inserts a player card into the card reader. When the card reader is inserted, an identification may be read from the card and transmitted to player account server 409. Player account server 409 transmits player information through network controller 210 to user interface 220 for display on the player tracking display. The player tracking display may provide a personalized welcome to the player, the player's current player points, and any additional personalized data. If the player has not previously made a selection, then this information may or may not be displayed. Once the player makes a personalizing selection, the information may be transmitted to game processor 205 for storing and use during the player's game play. Also, the player's selection may be transmitted to player account server 409 where it may be stored in association with the player's account for transmission to the player in future gaming sessions. The player may change selections at any time using the player tracking display (which may be touch sensitive or have player-selectable buttons associated with the various display selections).

In one or more embodiments, a gaming website may be accessible by players, e.g. gaming website 421, whereon one or more games may be displayed as described herein and played by a player such as through the use of personal computer 423 or handheld wireless device 425 (e.g. Blackberry® cell phone, Apple® iPhone®, personal data assistant (PDA), iPad®, etc.). To enter the website, a player may log in with a username (that may be associated with the player's account information stored on player account server 409 or be accessible by a casino operator to obtain player data and provide promotional offers), play various games on the website, make various personalizing selections, and save the information, so that during a next gaming session at a casino establishment, the player's playing data and personalized information may be associated with the player's account and accessible at the player's selected gaming machine 100.

Any use of ordinal terms such as “first,” “second,” “third,” etc., to refer to an element does not by itself connote any priority, precedence, or order of one element over another, or the temporal order in which acts of a method are performed. Rather, unless specifically stated otherwise, such ordinal terms are used merely as labels to distinguish one element having a certain name from another element having a same name (but for use of the ordinal term).

Further, as described herein, the various features have been provided in the context of various described embodiments, but may be used in other embodiments. The combinations of features described herein should not be interpreted to be limiting, and the features herein may be used in any working combination or sub-combination according to the invention. This description should therefore be interpreted as providing written support, under U.S. patent law and any relevant foreign patent laws, for any working combination or some sub-combination of the features herein.

The above described preferred embodiments are intended to illustrate the principles of the invention, but not to limit the scope of the invention. Various other embodiments and modifications to these preferred embodiments may be made by those skilled in the art without departing from the scope of the present invention.

1. A method of providing a wagering game on a gaming machine having a display, a wager input device, and at least one electronic controller operatively coupled to the wager input device and the display and configured to execute instructions related to the wagering game, the method comprising:
displaying a matrix of symbol location on the display, with every symbol location in the matrix having a symbol therein;
receiving a wager from a player at the wager input device, receiving a game activation at the gaming machine, and in response initiating the wagering game;
after initiating the wagering game, updating matrix of symbols locations to show a new set of symbols with every symbol location in the matrix having a symbol therein;
evaluating the game outcome to determine any prizes to be awarded by:
(a) defining zero or more groups of symbols by locating groups of horizontally or vertically contiguous symbols of designated types;
(b) counting the size of each defined group;
(c) highlighting or otherwise visually emphasizing each group of a designated minimum size;
(d) providing a prize for each group above the minimum size threshold, the prize based directly upon the size of the group.

2. The method of claim 1, wherein the step of highlighting or otherwise visually emphasizing the group includes displaying a number visually associated with the group on the display, the number being the size of the group.

3. The method of claim 1, wherein the designated types of symbols used to define groups are matching symbols.

4. The method of claim 1, in which the prize is further based directly on the type of symbol comprising the group.

5. The method of claim 4, further comprising, before receiving the game activation, offering the player a chance to choose among multiple betting arrangements, each awarding prizes for a different set of symbols forming groups.

6. The method of claim 1, further comprising, before receiving the game activation, offering the player a chance to choose among multiple betting arrangements, each awarding prizes for a different set of group sizes.

7. The method of claim 6, wherein the selection of a betting arrangement including designated small group sizes causes the game to include more symbol possibilities in the set of symbols used to update the matrix.

8. The method of claim 6, wherein selected betting arrangements in the multiple betting arrangements result in the game using a larger matrix of symbol locations than other better arrangements in the multiple betting arrangements.

9. The method of claim 1, wherein the matrix of symbol locations includes X (horizontal), Y (vertical), and Z (depth) dimensions with at least two symbol locations deep in the Z dimension, and wherein the groups may be formed additionally by being adjacent in the Z dimension.

10. The method of claim 1, wherein the set of symbols includes a wild symbol which may appear zero or more times each time the matrix is updated to show a new set of symbols, and wherein the step of defining zero or more groups includes counting the wild symbol as part of every group to which it is horizontally or vertically contiguous, and wherein the step of defining zero or more groups further includes, if two groups of similar symbols are separated by a wild symbol location, forming a larger group including the two groups and the wild symbol location.

11. The method of claim 10, wherein a free bonus round is included in the game which is activated by the appearance of a designated trigger condition in the matrix of symbols locations, and wherein the free bonus round includes multiple repetitions of updating the matrix of symbol locations with a new set of symbols, every location in the matrix receiving a symbol, and evaluating the matrix for groups similarly to the evaluation in claim 1, and further wherein the free bonus round includes a feature activated at least once in the round that recognizes when two groups of similar symbols are separated by a single symbol location which, if filled with a similar symbol would merge the two groups into a larger group, and after the updated matrix is shown to the player, displaying a graphic sequence of altering the single symbol location to be wild and thereby creating the larger group, and awarding a prize based on the size of the larger group.
